(19) United States
(12) Patent Application Publication
(10) Pub. No.: US 2006/0036994 A1
(43) Pub. Date: Feb. 16, 2006

(54) Hierarchical modeling method and software tool

(76) Inventors: Paul Jonathan Englefield, Warwickshire (GB); Mark Justin Paul Tibbits, Warwickshire (GB); Mark Andrew Farmer, Birmingham (GB); Wenjin Xu, Guangzhou (CN)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/202,892

(22) Filed: Aug. 12, 2005

(30) Foreign Application Priority Data
Aug. 13, 2004 (GB) 0418067.5

(51) Int. Cl. G06F 9/44

(52) U.S. Cl. 717/104; 717/127

(57) ABSTRACT

A method for manipulating a hierarchical model comprising a set of linked nodes, each represented by a graphic object on a display, is provided. The method comprises storing a node registry including data identifying nodes in the hierarchical model as well as the relationship between the nodes, displaying a representation of the hierarchical model to a user, and detecting a user selection of at least one displayed node. The method further includes detecting the position of a pointer on said display, displaying to a user, in dependence on the pointer position, an indication of a plurality of potential drop zones of a target node, each representing a potential target operation on the target node, detecting selection of one of said potential drop zones of said target node, and performing the target operation represented by the selected drop zone so as to add the at least one selected node in a particular relationship to said target node in said hierarchical model.

### BACKGROUND OF THE INVENTION

The present invention relates to the field of data processing and, in particular, to a method and software tool for manipulating representations of hierarchical models.

Graphical user interfaces are used in conjunction with a display and a user input to enable user interaction with graphic elements on the display. Typically, a user is provided with a cursor control device, such as a mouse, enabling the user to control one or more cursors on the display.

Software tools to support modeling activities typically represent the domain of interest as a network of nodes and arcs. One class of models, herein termed ‘hierarchical models’, concerns the abstract representation of hierarchical relationships such as taxonomies, bills of materials, module calling charts, organization charts and task models. In this case, the spatial positioning of one node with respect to another node conveys information about the hierarchical relationship between those two nodes. For example a child node is typically shown below a parent node and a peer node is shown adjacent to another peer.

Drag and drop provides a familiar, intuitive and efficient mechanism for moving and copying sets of nodes in support of iterative analysis and design. When working with a hierarchical model, a drop operation needs to convey two pieces of information: a) the target node onto which the dragged node(s) is(are) to be dropped; and b) the required relationship between the dragged node or nodes and the target node. For example, the user may wish to drop a dragged node as a peer before or after a target node or as a child node below a target node.

### SUMMARY OF THE INVENTION

A first aspect of the invention provides a method for manipulating a hierarchical model comprising a set of linked nodes, each represented by a graphic object on a display. The method comprises storing a node registry including data identifying nodes in the hierarchical model as well as the relationship between the nodes, displaying a representation of the hierarchical model to a user, and detecting a user selection of at least one displayed node. The method further includes detecting the position of a pointer on said display, displaying to a user, in dependence on the pointer position, an indication of a plurality of potential drop zones of a target node, each representing a potential target operation on the target node, detecting selection of one of said potential drop zones of said target node, and performing the target operation represented by the selected drop zone so as to add the at least one selected node in a particular relationship to said target node in said hierarchical model.

The user is thus provided with an indication of a plurality of available drop zones of a target node, each drop zone being associated with a different relationship to the target node. This allows a user to drop a node in the vicinity of the target node, and thereby indicate the target node and required relationship to that target node in a single gesture. According to a preferred embodiment, visual feedback is displayed to cue the required behavior, by indicating the presence and location of available related drop zones, and conveying the consequences of dropping on each such drop zone. This feedback could alternatively or additionally be provided in audio format.

According to a second aspect of the present invention there is provided a computer program product having program instructions operable to perform the method described above.

### BRIEF DESCRIPTION OF THE DRAWINGS

Preferred embodiments of the invention will now be described by way of example only and with reference to the accompanying drawings in which:

FIG. 1 shows a schematic representation of a data processing system according to an embodiment of the present invention;

FIG. 2a displays a hierarchical tree model;

FIGS. 2b to 2f display partial screenshots showing the indicators which are displayed during the manipulation of the hierarchical tree model of FIG. 2a;

FIG. 3 shows an indication of the various drop zones available for a leaf node;

FIG. 4 shows a text box provided by a context sensitive tool tip in accordance with a modification; and

FIG. 5 shows the process steps involved in moving or copying a node.

### DESCRIPTION OF PARTICULAR EMBODIMENTS

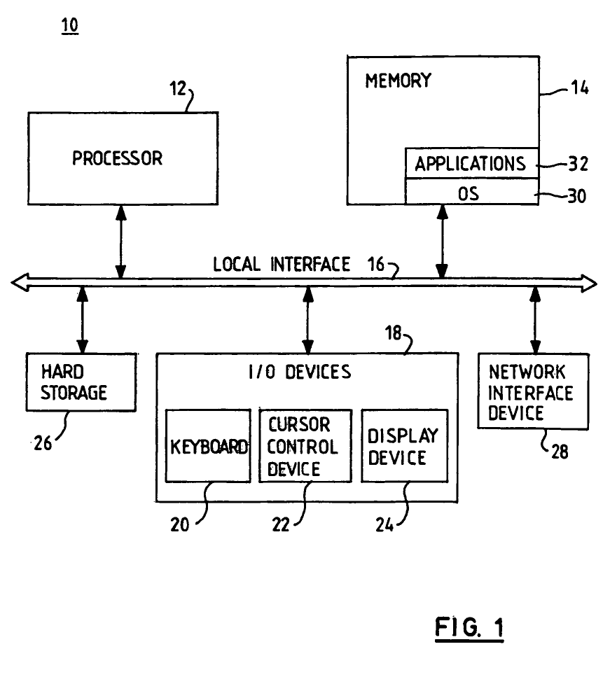

Referring to FIG. 1, there is shown a schematic and simplified representation of a data processing system 10 in which the present invention may be implemented. As shown in FIG. 1, the data processing system comprises a processor (CPU) 12, and memory 14 coupled to a local interface 16. One or more user-input devices 18, such as a keyboard 20, cursor control device 22 and display device 24 are connected to the local interface 16. Additionally, hard storage 26 and a network interface device 28 are provided.

Illustrated within memory 14 in FIG. 1, are operating system (OS) 30 and applications 32 which are currently being run on the data processing system 10. The OS is a software (or firmware) component of the data processing system 10 which provides an environment for the execution of programs by providing specific services to the programs including loading the programs into memory and running the programs. The OS also manages the sharing of internal memory among multiple applications and/or processes and handles input and output control, file and data management, communication control and related services. Application programs make requests for services to the OS through an application program interface (not shown).

The data processing system 10 may comprise, for example, a personal computer (PC), laptop, server, workstation, or a portable computing device, such as a personal digital assistant (PDA), mobile telephone or the like. Furthermore, data processing system 10 may comprise additional components not illustrated in FIG. 1, and, in other embodiments, may not include all of the components illustrated in FIG. 1.

Referring again to FIG. 1, the various components of data processing system 10 will be described. The processor 12 may be a hardware device for executing software located in memory 14, and may be any custom made or commercially available processor, a central processing unit (CPU), a semiconductor based microprocessor, a macro processor, or generally any device for executing software instructions.

Memory 14 may include any one or combination of volatile memory elements (e.g., random access memory (RAM, such as DRAM, SRAM, SDRAM, etc.)) and non-volatile memory elements (e.g., ROM, hard drive, tape, CDROM, DVDROM etc.). Memory 14 may incorporate electronic, magnetic, optical, and/or other types of storage media. Memory 14 may also have a distributed architecture, with various components being situated remotely from one another, but being accessible by the processor 12.

Local interface 16 may be, for example, one or more buses or other wired or wireless connections and may comprise additional elements which are omitted for simplicity, such as controllers, buffers (caches), drivers, repeaters, and receivers. Further, local interface 16 may include address, control, and/or data connections to enable appropriate communications among components of the data processing system 10.

Input/output (I/O) devices 18 may comprise any device configured to communicate with local interface 16. In FIG. 1, a keyboard 20, cursor control device 22 and display device 24 are shown. Additional input/output devices such as optical drives, floppy disk drives, cameras, I/O ports, printers, speakers, microphones, scanners, etc. could also be provided.

Cursor control device 22 may comprise any input device configured to cooperate with an application 32 and/or OS 30 and manipulate one or more cursor(s) displayed on the display device 24. For example, cursor control device 22 may comprise, but is not limited to: a mouse, a trackball, a set of navigation keys (e.g., arrow keys), a touchpad, a joystick or a touch sensitive screen.

Network interface device 28 may be any device configured to interface between the data processing system 10 and a computer or telecommunications network, such as a Local Area Network (LAN), a private computer network, a public or private packet-switched or other data network including the Internet, a circuit switched network, or a wireless network.

A computer program for implementing various functions or for conveying information may be supplied on carrier media such as one or more DVD/CD-ROMs 46, floppy disks 48, and/or USB storage devices and then stored on a hard disk, for example. The data processing system shown in FIG. 1 may be connected to a network such as the Internet, or a local or wide area dedicated or private network, for example, via the network interface device 28.

A program implementable by a data processing system may also be supplied on a telecommunications medium, for example over a telecommunications network and/or the Internet, and embodied as an electronic signal. For a data processing system operating as a wireless terminal over a radio telephone network, the telecommunications medium may be a radio frequency carrier wave carrying suitable encoded signals representing the computer program and data. Optionally, the carrier wave may be an optical carrier wave for an optical fibre link or any other suitable carrier medium for a telecommunications system.

A method of manipulating a graphical representation of a hierarchical model using a modeling tool in accordance with an embodiment of the invention will now be described. The modeling tool is an application 32 running on the data processing system 10. The modeling tool allows a user to manipulate a graphical representation of a hierarchical model shown on a display. The hierarchical model includes a plurality of nodes, which are related in a certain manner, and which can be represented by graphical objects on the display, the hierarchy/relationship of the nodes being indicated by the relevant positions of the nodes on the display and/or by the display of links between the nodes. Examples of hierarchical models include, inter alia, tree structures and indented lists.

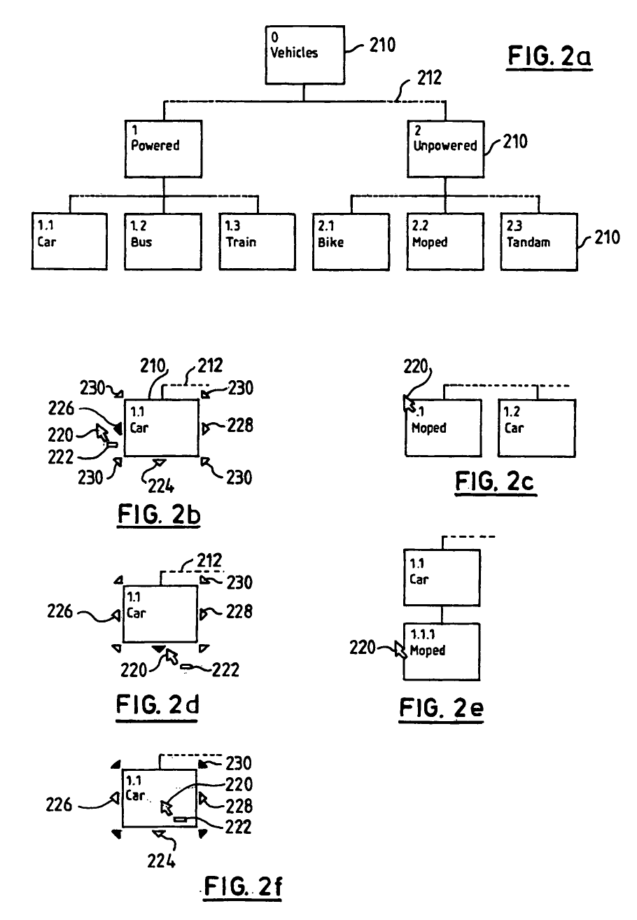

FIG. 2a shows a graphical representation of a hierarchical model which is in the form of a tree structure. The tree comprises a set of linked nodes 210, each being represented by a graphical object. Each node has zero or more child nodes, which are below it in the tree (trees typically grow down, not up). A node having one or more child nodes is called the parent of the child nodes. A node without a parent is called the root node, or root. Nodes with no children are called leaf nodes. In the example of FIG. 2a, the graphical object for each node is a box in which is displayed a node number and name. The name of the node is indicative of an object or task represented by the node. The number is indicative of the position of the object in the hierarchical model. The tree structure is ordered from left to right with a distinction made between the various children of a node: a node positioned on the left of one of its peers being higher up in the hierarchy than the peer node on the right.

Referring to FIG. 2a, the root node 0, called Vehicles, is a parent node to two child nodes 1, 2 called Powered and Non-powered respectively. Nodes 1 and 2 are peers of each other (indicated by the horizontal link 212). Nodes 1 and 2 in turn are parent nodes, having three children each: for node 1—Car 1.1, Bus 1.2, and Train 1.3; and for node 2—Bike 2.1, Moped 2.2, and Tandem 2.3.

The modeling tool allows a user to create and manipulate graphic objects representing a hierarchical model on a display. The modeling tool includes a graphic object model including attributes, such as the position on the screen, of each of the various graphic objects representing the nodes and links of the hierarchical model, and displays these node and link objects on a display. The modeling tool also includes a registry which includes a data entry for each of the nodes in the tree. The entry for each node contains at least its name and a reference to any child nodes which depend upon it, along with any order of the child nodes. The entry for each root node additionally includes an indication that it is a root node. From this registry, the hierarchy of the nodes can be ascertained.

The manipulation of the hierarchical model with which the present invention is mainly concerned is that of moving or copying one or more nodes, using a drag and drop mechanism. Additionally, the user may add or delete nodes or branches of the tree structure, for example.

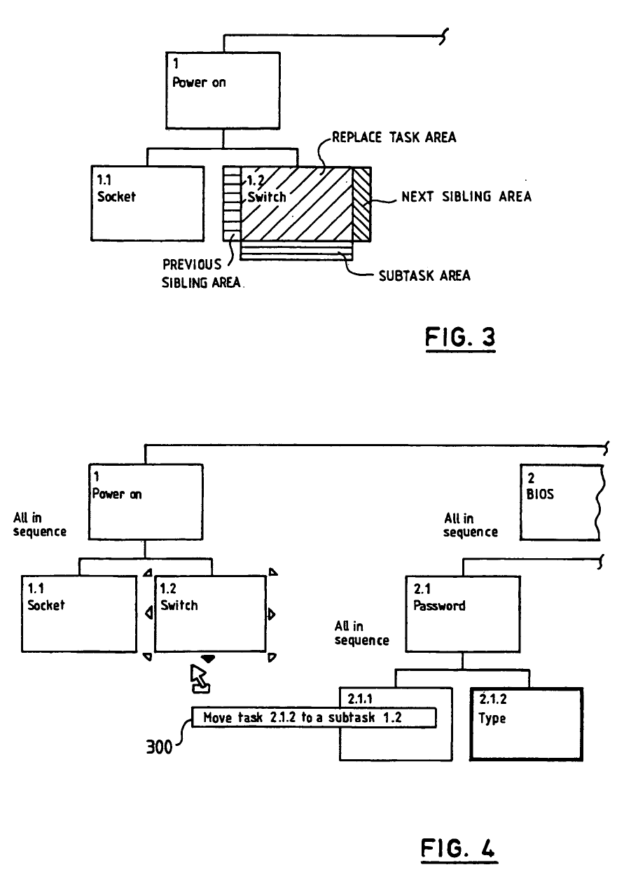

For each node object, the modeling tool also stores a plurality of drop zones which define areas on the display in the vicinity of the node object, as shown in FIG. 3, in relation to a Switch node in a task model embodiment. Each of these drop zones represents a different hierarchical relationship to that node and corresponds to a different drop operation on the node. A drop operation for a particular drop zone results in a source node being positioned in the hierarchical model in the relationship to the target node which is represented by that drop zone. Examples of relationships represented by drop zones include previous sibling, next sibling, child and replace. For a previous sibling drop zone the corresponding drop operation is to add a source node as a sibling of the target node, preceding the target node in the hierarchy, e.g. to the left of the target node in a tree structure ordered left to right. For a next sibling drop zone the corresponding drop operation is to add a source node as a sibling to the target node following the target node in the hierarchy. For a child drop zone the drop operation is to add a source node as a child of the target node; and for a replace drop zone the drop operation is to replace the target node with a source node.

To move or copy one or more node object a user selects the one or more nodes to be moved, which may be termed the ‘source’ node(s). This selection typically comprises the user moving a pointer on the display to a position over the node to be moved and then clicking a mouse or keyboard button. The pointer is then said to be ‘loaded’ with the source node or nodes. The particular user input may provide an indication as to whether the manipulation operation is intended to be a move operation or a copy operation. Each of these operations comprises two parts, the first part comprising a drag operation, which comprises moving the loaded cursor to a particular drop zone, and which is carried out by the user. For the move operation the second part comprises removing the source node(s) from the original position in the tree structure and adding the source node(s) to the tree hierarchy in the hierarchical position indicated by the target node and drop zone. In a copy operation, the second part comprises copying the graphic object(s) representing the source node(s) and adding these to the tree hierarchy in the hierarchical position indicated by the target node and drop zone.

When the loaded pointer is moved close to another node indicators of the possible available drop zones associated with that node appear. When the pointer position is coincident with a particular drop zone the indicator for that drop zone changes to show that a drop action will result in the source node being positioned next to the target node, according to the relationship represented by that drop zone.

In response to a drop operation by a user in a drop zone, the modeling tool detects the position of the pointer, determines which drop zone has been actioned and carries out the appropriate manipulation operation.

Referring to FIG. 2a, the user may wish to reposition the possibly misplaced Moped node within the model. The user selects the Moped node as the source node. This loads the cursor with the Moped node, and the form of the cursor may change to indicate that it is loaded. The user then moves the cursor near to the target node, next to which it is desired to drop the Moped node. For example, as shown in FIG. 2b, the user drags Moped to the area to the left of the target node Car. When the cursor nears the target node, indicators of the possible available drop zones appear. When the cursor position is coincident with a particular drop zone the indicator for that drop zone changes to indicate that it is the active drop zone, that is that a drop action will result in the dragged node being positioned with respect to the target node according to the relationship associated with that drop zone.

As shown in FIG. 2b, the cursor is in the form of arrow 220 with a small rectangle 222 below it indicating that the cursor is loaded. Triangles 224, 226, 228 and 230 appear as indicators of the available drop zones for the target node Car, namely one 226 to the left of Car, one 224 below Car, one 228 to the right of Car, and one 230 at each corner of Car pointing towards the center of the Car node. The direction in which each triangle points indicates the relationship to the target node which is represented by its drop zone. So, the triangle pointing left indicates that source node(s) dropped to the left of the target node, will be added to the left of the target node in the tree hierarchy, that is as a preceding sibling; the one pointing right indicates that the source node(s) dropped to the right of the target node will be positioned to the right of the target node in the tree hierarchy, that is as a following sibling; the triangle pointing downwards indicates that the source node(s) dropped in a drop zone underneath the target node will be positioned under the target node in the hierarchy, that is as a child of the target node; and the triangles 230 pointing into the Car node indicate that source node(s) dropped on top of the target node will replace the target node.

The solid left-pointing triangle 226 indicates the active drop zone, which is currently coincident with the loaded cursor, and in FIG. 2b indicates the relationship of the addition of a peer node to the left of Car. When the previous sibling drop zone is not the active drop zone, triangle 226 has the same form as the other inactive indicators 224, 228. When the cursor is not loaded, or not coincident with any of the drop zones for a target node, the drop zone indicators do not appear.

Referring to FIG. 2c, on releasing the mouse, the node is added at the required position, to the left of Car, as one of its peers. The numbering appearing on the children to the Powered node is reallocated according to the new node positions. The load indicator 222 disappears from the cursor 220 to show that the cursor is no longer loaded.

In the example shown in FIGS. 2d and 2e, the user has employed a similar gesture to make Moped a child of Car by dropping in the drop zone below the Car node. Note that by dragging to the drop zone to the right of Car, the user could alternatively have dropped Moped as a peer after Car.

In the example of FIG. 2f, Car may be replaced by Moped by dropping Moped on the drop zone within the target node Car.

Thus the indicator triangles show: i) that multiple alternative drop zones are available, ii) the position of those drop zones, and iii) the logical relationship to the target node of a node inserted by dropping on that drop zone. Further feedback might be provided by a context sensitive tool-tip, describing the action associated with the drop zone in words, as shown in FIG. 4, which shows an alternative embodiment in which the hierarchical model is a task model, with each node being represented by an image of a sticky note.

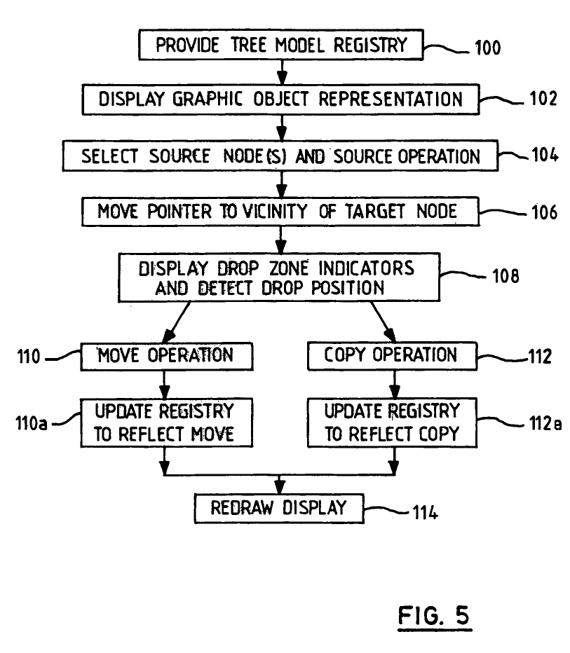

Referring to FIG. 5, the process steps involved in manipulation of the tree structure will now be described. The modeling tool is provided 100 with a tree model registry, from which it can create a tree structure which can be represented on a display by a plurality of graphic objects 102. The user selects 104 a node and selects an operation to be carried out in respect of the selected source node, i.e. move or copy. If the selected node has one or more child nodes, then this selection step may designate all nodes in the branch descending from the selected node as source nodes. The user then moves 106 the pointer towards the target node to which the user wishes to attach the source node(s). When the loaded pointer is in the vicinity of a node, drop zone indicators are displayed 108. When the user carries out a drop operation (for example by releasing a mouse button), the tool detects the geometric relation of the pointer location at the time of the drop operation to the target node's drop zones, and thus determines the selected relationship to the target node.

The modeling tool then carries out the pre-selected operation 110, 112 to effect the move or copy of the source node(s). It updates 110a, 112a the node registry to reflect the change effected by that operation. For a move operation, reference to the selected node is deleted from the register entry for the original parent of the selected node, and reference to the selected node is added to the register entry for the node now designated as its parent, according to the relationship to the target node which is indicated by the drop operation. For example if the selected node is dropped as a child of the target node, the entry for the target node is updated to list the selected node as a child to it. For a copy operation, reference to the selected node as a child is added to the register entry for its new parent node, with the entry for the selected node's original parent node remaining unchanged.

The modeling tool can then redraw 114 the display to show the changes to the hierarchical model. Each changed node is allocated a new number to indicate its new position in the tree, but retains its graphic representation and name. Any siblings or other family members subsequent to the moved node(s) is(are) renumbered accordingly. For example, referring to FIG. 2a, when Moped is moved, the node Tandem will be renumbered as node 2.2 in the tree. The tree model is then redrawn on the screen to show the change that has been effected.

In a preferred embodiment, the modeling tool is implemented using Java Foundation Classes (Java and all Java-based trade marks are trade marks of Sun Microsystems Inc.). However, equivalent functionality is available in windowing tool kits for most commercial platforms.

In contrast with the prior art menu solution described earlier, only a single gesture is required and that gesture is conceptually consistent with the drag and drop paradigm and the user's spatial model of the required relationship to the target node. Additionally, the drop zone indicators emphasize the range of distinct actions available to the user with a strong indication as to their effect.

Insofar as embodiments of the invention described are implementable, at least in part, using a software-controlled programmable processing device or, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disc or tape, optically or magneto-optically readable memory such as compact disk (CD) or Digital Versatile Disk (DVD) etc, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the preceding example embodiments, the invention is not limited thereto and that there are many possible variations and modifications which fall within the scope of the invention.

1. A computer implemented method for manipulating a hierarchical model comprising a set of linked nodes, each represented by a graphic object on a display, the method comprising the steps of:
storing a node registry including data identifying nodes in the hierarchical model as well as the relationship between the nodes;
displaying a representation of the hierarchical model to a user;
detecting a user selection of at least one displayed node;
detecting a position of a pointer on said display;
displaying to a user, in dependence on the pointer position, an indication of a plurality of potential drop zones of a target node, each representing a potential target operation on the target node;
detecting selection of one of said potential drop zones of said target node; and
performing the target operation represented by the selected drop zone so as to add the at least one selected node in a particular relationship to said target node in said hierarchical model.

2. A method according to claim 1, wherein each potential target operation adds the selected node at a position in the hierarchical model in a particular hierarchical relationship to the target node.

3. A method according to claim 2, further comprising updating the node registry to add the at least one selected node as a node in the hierarchical model having a hierarchical relationship to the target node represented by the selected drop zone.

4. A method according to claim 1, wherein the node registry includes a data entry for each node in the hierarchical model, each data entry identifying any child nodes to which its node is related.

5. A method according to claim 1, wherein the node registry identifies root nodes in the tree hierarchy.

6. A method according to claim 1, further comprising the step of selecting a source operation to carry out in respect of a selected node.

7. A method according claim 6, wherein said updating step includes updating the node registry to effect the selected source operation on a selected node.

8. A method according to claim 6, wherein said selected source operation comprises maintaining each selected node in its original position in the hierarchical model, the target operation adding a copy of each selected node in hierarchical relationship to the target node in accordance with the selected drop zone.

9. A method according to claim 6, wherein said selected source operation comprises deleting each selected node from its original position in the hierarchical model, the target operation adding each selected node in hierarchical relationship to the target node, so as to move a selected node.

10. A method according to claim 1, further comprising the step of changing the form of said pointer on said display in response to detection of said user selection of at least one displayed node.

11. A method according to claim 1, further comprising the step of storing the positions of graphic objects representing said tree hierarchy on a display, comparing said pointer position with said graphic object positions; and displaying an indication of the potential drop zones of a node if it is represented by an object in the vicinity of the pointer.

12. A method according to claim 11, further comprising the step of maintaining a record of attributes relating to each of said graphic objects.

13. A method according to claim 1, wherein said step of displaying an indication of potential drop zones comprises displaying to the user, in dependence upon the position of the pointer being coincident with a potential drop zone, text indicating the manipulation performed by selection of that drop zone.

14. A method according to claim 1, wherein said step of displaying an indication of potential drop zones comprises displaying an indication of drop zones representing the relationships of preceding sibling, subsequent sibling and child to a target node.

15. A method according to claim 1, wherein a potential target operation represented by one of the potential drop zones is to replace the target node with the at least one selected node in the hierarchical model.

16. A method according to claim 1, further comprising the step of redrawing the hierarchical model on the display to show the manipulation.

17. A computer-usable medium embodying computer program code, the computer program code comprising computer executable instructions configured to:
store a node registry including data identifying nodes in the hierarchical model as well as the relationship between the nodes;
display a representation of the hierarchical model to a user;
detect a user selection of at least one displayed node;
detect a position of a pointer on said display;
display to a user, in dependence on the pointer position, an indication of a plurality of potential drop zones of a target node, each representing a potential target operation on the target node;
detect selection of one of said potential drop zones of said target node; and
perform the target operation represented by the selected drop zone so as to add the at least one selected node in a particular relationship to said target node in said hierarchical model.

18. The computer-usable medium of claim 17, wherein the embodied computer program code further comprises computer executable instructions configured to change the form of said pointer on said display in response to detection of said user input selection of at least one displayed node.

19. The computer-usable medium of claim 17, wherein the embodied computer program code further comprises computer executable instructions configured to update the node registry to add the at least one selected node as a node in the hierarchical model having a hierarchical relationship to the target node represented by the selected drop zone.

20. The computer-usable medium of claim 17, wherein the node registry includes a data entry for each node in the hierarchical model, each data entry identifying any child nodes to which its node is related.
